(19) United States
(12) Patent Application Publication
(10) Pub. No.: US 2022/0377983 A1
(43) Pub. Date: Dec. 1, 2022

(54) HARVESTING HEADERS HAVING AN OIL LEVEL INDICATOR, AND RELATED AGRICULTURAL VEHICLES AND METHODS

(71) Applicant: AGCO Corporation, Duluth, GA (US)

(72) Inventors: Friedrich Robert Honeyman, Hesston, KS (US); Kevin J. Hamilton, Newton, KS (US); Grant Lewis Good, Moundridge, KS (US)

(21) Appl. No.: 17/755,799

(22) PCT Filed: Jun. 8, 2020
(86) PCT No.: PCT/IB2020/055355

§ 371 Date: May 9, 2022

Related U.S. Application Data
(60) Provisional application No. 62/931,934, filed on Nov. 7, 2019.

(51) Int. Cl. A01D 69/12; F01M 11/12

(52) U.S. Cl. CPC A01D 69/12; F01M 11/12

(57) ABSTRACT

A harvesting header includes a header frame, rotary cutters carried by the header frame, a gearbox containing at least one gear coupled to each rotary cutter, and an electronic sensor to indicate an amount of oil in the gearbox. Each rotary cutter has a rotating disc with at least one blade for cutting crops. An agricultural vehicle includes a vehicle frame, at least one attached to the vehicle frame, and a harvesting header coupled to the vehicle frame by a plurality of hydraulic cylinders. A method of operating an agricultural vehicle includes adjusting at least one hydraulic cylinder to move a header frame to a known orientation, sensing a position of an oil surface in a gearbox, and determining or indicating an amount of oil in the gearbox based at least in part on the position of the oil surface.

### CROSS-REFERENCE TO RELATED APPLICATION

This application claims the benefit of the filing date of U.S. Provisional Patent Application 62/931,934, filed Nov. 7, 2019, the entire disclosure of which is incorporated herein by reference.

### FIELD

This disclosure relates to harvesting headers used on agricultural vehicles for harvesting an agricultural crop, and more particularly to a system for evaluating oil level in a header without draining the oil.

### BACKGROUND

Harvesters or windrowers are self-propelled or tractor-drawn farm implements used to mow a field and arrange mown crop in rows or “windrows.” Some windrowers, such as disc windrowers, use headers including rotating blades to cut stalks of grain or other crops. The rotating blades are driven by gears, and include lubricating oil in a sealed gearbox surrounding the gears. A lack of oil in the gearbox (e.g., due to an oil leak) can lead to catastrophic failure of the gears. The typical long and flat geometry of the gearbox and the harshness of the conditions in which the gearbox operates makes determining the amount of oil in the gearbox difficult. Typically, the gearbox is drained and the amount of oil removed is measured and compared against an expected oil amount. The oil is commonly replaced with fresh oil.

### BRIEF SUMMARY

A harvesting header includes a header frame, a plurality of rotary cutters carried by the header frame, a gearbox containing at least one gear coupled to each rotary cutter, and an electronic sensor configured to indicate an amount of oil in the gearbox. Each rotary cutter has a rotating disc with at least one blade for cutting crops extending from the rotating disc.

An agricultural vehicle includes a vehicle frame, at least one wheel attached to the vehicle frame, and a harvesting header coupled to the vehicle frame by a plurality of hydraulic cylinders. In the case of a self-propelled windrower, the vehicle frame also includes a source of power, a means of transferring that power to the header and to the wheels for header drive and propulsion. In the case of a mower implement, the vehicle frame includes a means of receiving power from a tractor, and a way of attaching to or being drawn by the tractor. The harvesting header includes a header frame, a plurality of rotary cutters carried by the header frame, a gearbox containing at least one gear coupled to each rotary cutter, and an electronic sensor configured to indicate an amount of oil in the gearbox. Each rotary cutter has a rotating disc with at least one blade for cutting crops extending from the rotating disc.

A method of operating an agricultural vehicle includes adjusting at least one hydraulic cylinder coupling a header frame of a harvesting header to the agricultural vehicle to move the header frame to a known orientation, sensing or indicating a position of an oil surface in a gearbox coupled to the header frame and containing a plurality of gears, and determining or indicating an amount of oil in the gearbox based at least in part on the position of the oil surface.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified perspective view of an agricultural vehicle carrying a harvesting header;

FIG. 2 is a simplified perspective view of a cutting assembly of the harvesting header shown in FIG. 1;

FIG. 3 includes simplified cutaway front views of the harvesting header in a level orientation (FIG. 3A) and tilted (FIG. 3B);

FIG. 4 is a simplified front cutaway view of another harvesting header;

FIG. 5 is a simplified view of a control system for the harvesting header;

FIG. 6 is a flow chart illustrating a method of operating an agricultural harvester; and

FIG. 7 illustrates an example computer-readable storage medium comprising processor-executable instructions configured to embody one or more of the methods of operating an agricultural harvester, such as the method illustrated in FIG. 6.

### DETAILED DESCRIPTION

The illustrations presented herein are not actual views of any header or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

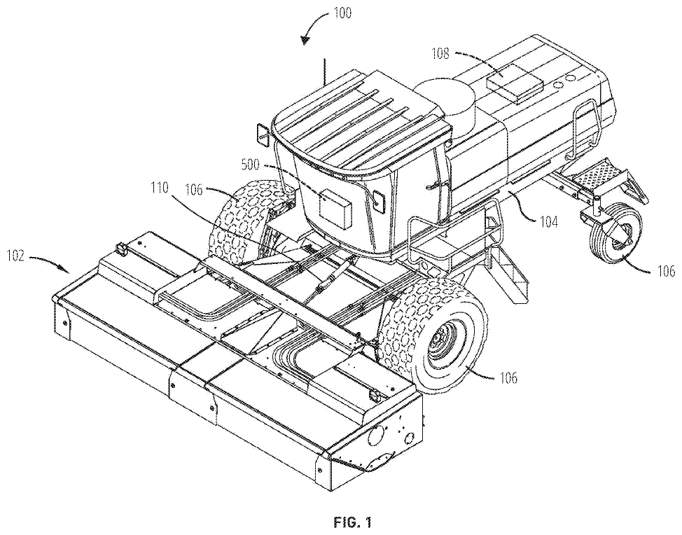

FIG. 1 illustrates an agricultural vehicle 100 in the form of a windrower carrying a header 102 configured for cutting grasses or other crops. The agricultural vehicle 100 may include a vehicle frame 104, wheels 106, and a hydraulic manifold 108. A control system 500 may be carried by the agricultural vehicle 100 and operable to adjust operating parameters of the header 102, such as pitch, height, and blade speed. Typically, the position of the header 102 with respect to the agricultural vehicle 100 (including pitch, height, and tilt) may be controlled by changing the position of one or more hydraulic cylinders 110 (of which only one is visible in FIG. 1). Though depicted as a windrower, the agricultural vehicle 100 may be a harvester, a pull-behind mower, or any other agricultural vehicle having headers or similar rotary blade configurations.

The wheels 106 may be rotatably attached to the vehicle frame 104 and may support the vehicle frame 104 a distance above the ground. The agricultural vehicle 100 may include an engine, motor, or any actuator configured to actuate the wheels 106, thus propelling the vehicle frame 104 forward or backwards. The hydraulic manifold 108 may be configured to receive commands from and be controlled by elements of the control system 500, and may be used to actuate hydraulic cylinders, pumps, and/or motors of the agricultural vehicle 100.

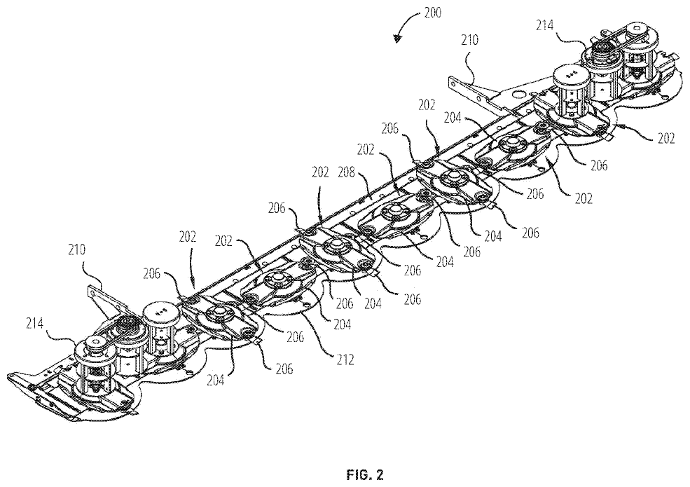

FIG. 2 is a simplified perspective view illustrating a cutting assembly 200 of the header 102 shown in FIG. 1. The header 102, also sometimes referred to as a rotary cutter bed, may be any header known in the art, such as the header and rotary cutter bed described in U.S. Pat. No. 8,656,694, “Auxiliary Drive Motor for Hay Conditioner on a Windrower header,” issued Feb. 25, 2014. The header 102 may include one or more rotary cutters 202. The rotary cutters 202 may include discs 204 with blades 206 attached thereto. For example, the discs 204 may be rotatably attached to a header frame 208 attached to and configured to be pushed in front of the vehicle frame 104 as the agricultural vehicle 100 travels forward. The header frame 208 may include a support beam coupled to brackets 210. The discs 204 may rotate in a plane substantially perpendicular to a plane in which wheels 106 (e.g., front wheels) of the agricultural vehicle 100 rotate. As illustrated in FIG. 2, the discs 204 may be substantially oval or oblong and may have two blades 206 or knives affixed thereto and extending from opposing ends thereof.

The cutting assembly 200 may also include a rock guard 212 attached to the header frame 208 of the cutting assembly 200 and/or the vehicle frame 104 of the agricultural vehicle 100. The rock guard 212 may be a rigid plate or a series of rigid plates fixed relative to each other and mounted below the discs 204. As illustrated in FIG. 2, the rock guard 212 may extend further forward (relative to a direction of travel of the agricultural vehicle 100) than the discs 204, while still allowing at least a portion of the blades 206 to extend outward beyond the rock guard 212 as the discs 204 rotate.

Transmission assemblies 214 may be configured to drive rotation of the discs 204. The transmission assemblies 214 may be driven by pressurized hydraulic fluid provided by the agricultural vehicle 100. The transmission assemblies 214 may be mechanically or electrically driven from a power source. In some embodiments, cutters of opposite rotational orientations are arranged in alternating succession. Specifically, the rotary cutters 202 may be ninety degrees out of phase with respect to the adjacent rotary cutters 202, particularly if circular paths of travel of the blades 206 of adjacent rotary cutters 202 overlap one another and therefore must be appropriately out of phase in order to avoid striking each other. The cutting assembly 200 may also include a positive mechanical drive connection between the rotary cutters 202 or discs 204 such that the rotary cutters 202 or discs 204 remain properly in phase with one another when actuated to rotate at any speed.

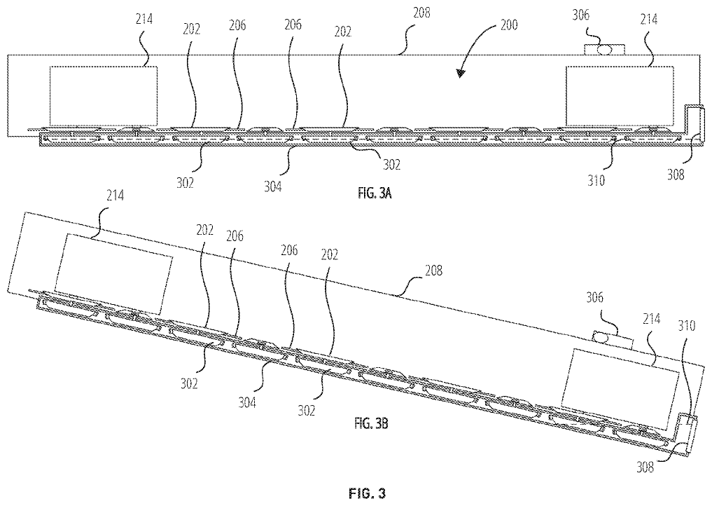

FIG. 3 contains simplified front views of the cutting assembly 200 in a level orientation (FIG. 3A) and in a tilted orientation (FIG. 3B). As shown, the rotary cutters 202 may each be coupled to one of a plurality of gears 302 disposed in a gearbox 304. The gearbox 304 may run along the length of the cutting assembly 200 underneath the rotary cutters 202. The gearbox 304 may be sealed to keep lubricating oil in the gearbox 304, such that the oil can lubricate the gears 302. The shape of the gearbox 304 may be generally long and flat, with a relatively small height (e.g., 10 cm or less, 5 cm or less, or even 3 cm or less).

The small height of the gearbox 304 enables the blades 206 of the rotary cutters 202 to operate closer to ground level than a taller gearbox would, but introduces difficulty in monitoring the level of the oil in the gearbox 304. In particular, conventional methods of monitoring oil level (e.g., a dipstick, a sight glass, a float, etc.) are problematic because the vertical distance between the proper level of the oil surface 310 and a dangerously low level of the oil surface 310 may be small and difficult to detect.

The gearbox 304 may include an oil level indicator 308. As shown, the gearbox 304 may be shaped at one end (the right side in the embodiment shown in FIG. 3) to have a portion that has a height that extends above the height of the rotary cutters 202. The additional height near the oil level indicator 308 may enable detection of the amount of oil in the gearbox 304 when the header frame 208 is tilted. For example, and as shown in FIG. 3B, when the header frame 208 is tilted to the right, the oil tends to flow toward the oil level indicator 308. The oil surface 310 may then be detected using the oil level indicator 308. The oil level indicator 308 may include any sensor for observing the oil surface 310, such as a sight glass, a dip stick, a float, an electronic sensor, etc.

The height of the oil surface 310 as observed with the oil level indicator 308 may depend not only on the amount of the oil in the gearbox 304, but also on the orientation of the header frame 208. Thus, the header frame 208 may also carry a header angle indicator 306 to indicate the orientation of the header frame 208. The header angle indicator 306 may include a reference level having one or more fluids (e.g., a liquid with a gas bubble in a sight glass) separate from the oil in the gearbox 304. In some embodiments, the header angle indicator 306 may be an electronic sensor. In certain embodiments, the header angle indicator 306 may include one or more distance sensors coupled to the hydraulic cylinders 110 and configured to measure the distance from the hydraulic cylinder(s) 110 a known reference point. When the header frame 208 is in an angled position, the operator may use the oil level indicator 308 to determine the amount of oil in the gearbox 304 based on the level shown on the header angle indicator 306. In some embodiments the header angle indicator 306 may be omitted, and the oil level indicator 308 may be used when the header frame 208 is tilted as far as possible to one side.

In certain embodiments, the header angle indicator 306 may be configured to send a signal corresponding to the orientation of the header frame 208 (e.g., an electrical signal, a radio signal, etc., via wired or wireless connection) to the control system 500 of the agricultural vehicle 100. The operator of the agricultural vehicle 100 may direct the control system 500 to tilt the header frame 208 to a known position. For example, the control system 500 may adjust hydraulic cylinders 110 responsive to an operator input to the control system 500.

Once the header frame 208 reaches the preselected orientation, the oil level indicator 308 may detect the oil surface 310 and correlate that information to the amount of oil in the gearbox 304. The oil level indicator 308 may likewise be configured to send a signal corresponding to the detected amount of oil in the gearbox 304 to the control system 500, which may relay the information to the operator (e.g., as a warning or status indicator on a graphical user interface).

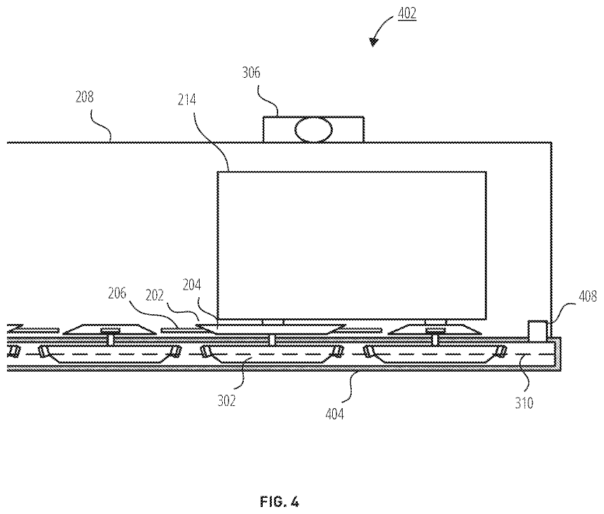

FIG. 4 is a simplified front view of a portion of another header 402. The header 402 differs from the header 102 in that the gearbox 404 of the header 400 lacks a portion having additional height (i.e., the portion housing the oil level indicator 308). That is, the gearbox 404 of the header 402 shown in FIG. 4 is generally long and flat, with a relatively small height throughout its length and width (e.g., 10 cm or less, 5 cm or less, or even 3 cm or less). An oil level indicator 408 is configured to detect the oil surface 310 within the gearbox 404. The oil level indicator 408 may be an electronic sensor, such as an acoustic sensor (including without limitation an acoustic transducer, a device that transmits an acoustic signal and detects a reflected acoustic signal), an optical sensor, a capacitive sensor, etc. The oil level indicator 408 may transmit a signal that intersects the oil surface 310 and reflects back to the oil level indicator 408. In other embodiments, the oil level indicator 408 may be configured to transmit a signal that passes through the oil. In some embodiments, the oil level indicator 408 may be configured to transmit a signal below the oil surface 310 toward a wall (e.g., a side wall, a floor, etc.) of the gearbox 404. In certain embodiments, the oil level indicator 408 may be configured to transmit a signal in a head space above the oil surface 310 of the gearbox 404. The oil level indicator 408 may use, for example, the time between transmission and receipt of the signals to determine the distance from the oil level indicator 408 to the oil surface 310. This distance may be used to calculate the location of the oil surface 310 and thus, the amount of oil in the gearbox 404. In some embodiments, the oil level indicator 408 may be used to identify a physical property of the oil in the gearbox 404 (e.g., electrical conductivity, viscosity, density, etc.), which may assist an operator in determining whether an oil change is required. For example, the oil level indicator 408 may determine oil life as disclosed in U.S. Pat. No. 6,741,938, “Method for continuously predicting remaining engine oil life,” issued May 25, 2004.

As with the oil level indicator 308 shown in FIG. 3, the orientation of the header frame 208 and gearbox 404 may affect the position of the oil surface 310. Thus, the header frame 208 may carry a header angle indicator 306 as described above. The header angle indicator 306 may be configured to send a signal to the control system 500.

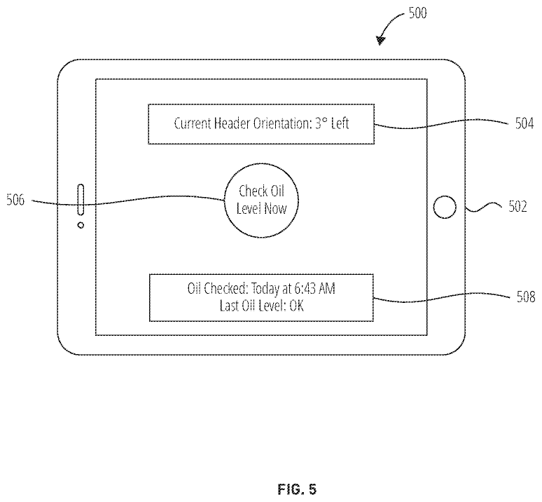

FIG. 5 is a simplified view of a control system 500 that may in the cab of the agricultural vehicle 100 shown in FIG. 1. The control system 500 may include a display panel 502, depicted as touch-screen. In other embodiments, the display panel 502 may include a display only (i.e., without an integrated user input) or a series of indicator lights or gauges. The control system 500 may, in such embodiments, include another input means, such as a keyboard, mouse, switches, buttons, etc. The display panel 502 may include an orientation display 504 configured to provide information about the orientation of the header frame 208. The display panel 502 may also include a button 506 configured to initiate a sequence to check the amount of oil in the gearbox 304, 404. An oil status indicator 508 may provide information on the results of the most recent test. If the most recent test indicates a low oil amount, the display panel 502 may also display a separate warning designed to draw the operator's attention (e.g., a flashing indicator, a different color, etc.).

The operator of the agricultural vehicle 100 may direct the control system 500 to bring the header frame 208 of the header 402 to a horizontal position (i.e., not tilted left or right). Once the header frame 208 reaches the horizontal orientation, the oil level indicator 408 may detect the oil surface 310 and correlate that information to the amount of oil in the gearbox 404. The oil level indicator 408 may likewise be configured to send a signal corresponding to the detected amount of oil in the gearbox 404 to the control system 500, which may relay the information to the operator (e.g., as a warning or status indicator on a graphical user interface).

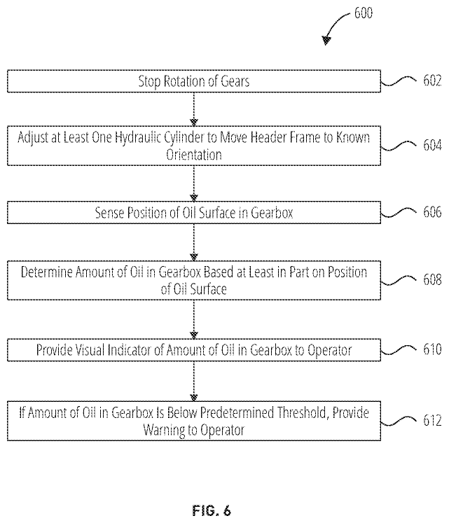

FIG. 6 is a simplified flow chart illustrating a method 600 in which the header 102 or header 402 may be used for harvesting an agricultural field. In block 602, rotation of the gears within a gearbox is stopped so that a position of the oil surface in the gearbox may be accurately detected.

In block 604, at least one hydraulic cylinder coupling a header frame of a harvesting header to the agricultural vehicle is adjusted to move the header frame to a known orientation. The header frame may be moved to a substantially horizontal position or to a tilted position. The hydraulic cylinders may be controlled by a control system associated with the agricultural vehicle. The orientation of the header frame may be measured before, during, and/or after the adjustment.

In block 606, the position of the oil surface in the gearbox is sensed with, for example, a dipstick, a sight glass, a float, an electronic sensor such as an acoustic transducer, etc. In some embodiments, a signal corresponding to the position of the oil surface may be transmitted to the agricultural vehicle (e.g., to the control system or another computer).

In block 608, an amount of oil in the gearbox is determined based at least in part on the position of the oil surface and optionally, based in part on the orientation of the header frame. In some embodiments, an angle of the header frame and the position of the oil surface may be correlated to a table of gearbox oil volumes (e.g., stored in a computer memory).

In block 610, a visual indicator of the amount of oil in the gearbox is provided to an operator of the agricultural vehicle. For example, the visual indicator may be provided on a graphical user interface of the control system.

If the amount of oil in the gearbox is determined to be below a predetermined threshold, a warning is provided to an operator of the agricultural vehicle, as indicated in block 612. The warning may be a visual indicator, an audible alert, a tactile alert, etc.

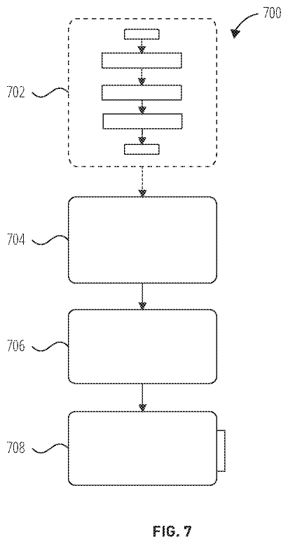

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 7, wherein an implementation 700 includes a computer-readable storage medium 702 (e.g., a flash drive, CD-R, DVD-R, application-specific integrated circuit (ASIC), field-programmable gate array (FPGA), a platter of a hard disk drive, etc.), on which is computer-readable data 704. This computer-readable data 704 in turn includes a set of processor-executable instructions 706 configured to operate according to one or more of the principles set forth herein. In some embodiments, the processor-executable instructions 706 may be configured to cause a computer associated with the agricultural vehicle 100 (FIG. 1) to perform operations 708 when executed via a processing unit, such as at least some of the example method 600 depicted in FIG. 6. In other embodiments, the processor-executable instructions 706 may be configured to implement a system, such as at least some of the example header 102, 402 and agricultural vehicle 100. Many such computer-readable media may be devised by those of ordinary skill in the art that are configured to operate in accordance with one or more of the techniques presented herein.

The small height of the gearbox 304, 404 enables the blades 206 of the rotary cutters 202 to operate closer to ground level than a taller gearbox would, but introduces difficulty in monitoring the level of the oil in the gearbox 304, 404. In particular, conventional methods of monitoring oil level (e.g., a dipstick, a sight glass, a float, etc.) are problematic because the vertical distance between the proper level of the oil surface 310 and a dangerously low level of the oil surface 310 may be small and difficult to detect. The arrangement of the oil level indicator 308, 408 overcomes this difficulty.

In the embodiments shown in FIG. 3 and FIG. 4, it may be desirable to stop rotation of the gears 302 to allow the oil surface 310 to reach a steady-state condition (i.e., substantially free of movement). Thus, the operator may generally stop movement of the agricultural vehicle 100, the header 102, 402, and the gears 302 before the oil level indicator 308, 408 provides a useful indication of the oil surface 310. Nonetheless, stopping movement may be performed relatively faster than conventional methods of measuring oil volume—draining the oil from the gearbox. Thus, using the oil level indicator 308, 408 described herein, the operator may easily check the oil level quickly in the field before beginning operations, or after the header 102, 400 has received damage (e.g., from a large rock or other obstacle) to ensure that the gearbox 304, 404 has sufficient oil to lubricate the gears 302. Furthermore, the oil level may be determined without opening the gearbox 304, 404 and without removing any oil from the gearbox 304, 404.

Additional non-limiting example embodiments of the disclosure are described below.

Embodiment 1: A harvesting header comprising a header frame, a plurality of rotary cutters carried by the header frame, a gearbox containing at least one gear coupled to each rotary cutter, and an electronic sensor configured to indicate an amount of oil in the gearbox. Each rotary cutter has a rotating disc with at least one blade for cutting crops extending from the rotating disc.

Embodiment 2: The harvesting header of Embodiment 1, wherein the electronic sensor comprises an acoustic sensor.

Embodiment 3: The harvesting header of Embodiment 2, wherein the acoustic sensor is configured to transmit an acoustic signal toward an oil surface in the gearbox and receive a reflected acoustic signal from the oil surface in the gearbox.

Embodiment 4: The harvesting header of Embodiment 2, wherein the acoustic sensor is configured to transmit an acoustic signal below an oil surface in the gearbox and receive a reflected acoustic signal from the gearbox.

Embodiment 5: The harvesting header of Embodiment 2, wherein the acoustic sensor is configured to transmit an acoustic signal into a head space in the gearbox above an oil surface and receive a reflected acoustic signal from the head space.

Embodiment 6: The harvesting header of Embodiment 1, wherein the electronic sensor comprises an optical sensor.

Embodiment 7: The harvesting header of Embodiment 6, wherein the optical sensor is configured to transmit an optical signal and receive a reflected optical signal from the surface of the oil.

Embodiment 8: The harvesting header of Embodiment 6, wherein the optical sensor is configured to transmit an optical signal through the oil.

Embodiment 9. The harvesting header of Embodiment 1, wherein the electronic sensor comprises a capacitive sensor.

Embodiment 10: The harvesting header of any one of Embodiment 1 through Embodiment 9, wherein the electronic sensor is configured to identify a physical property of oil in the gearbox.

Embodiment 11: The harvesting header of any one of Embodiment 1 through Embodiment 10, wherein the harvesting header further comprises a header angle indicator.

Embodiment 12: The harvesting header of Embodiment 11, wherein the header angle indicator comprises a reference level comprising a fluid container fluidly separate from the gearbox.

Embodiment 13: The harvesting header of Embodiment 11 or Embodiment 12, wherein the header angle indicator comprises an electronic sensor.

Embodiment 14: The harvesting header of any one of Embodiment 11 through Embodiment 13, wherein the header angle indicator comprises a sight glass.

Embodiment 15: The harvesting header of any one of Embodiment 11 through Embodiment 14, wherein the oil level indicator is configured to indicate the amount of oil in the gearbox based at least in part on information from the header angle indicator.

Embodiment 16: An agricultural vehicle comprising a vehicle frame, at least one wheel attached to the vehicle frame, and the harvesting header of any one of Embodiment 1 through Embodiment 15 coupled to the vehicle frame by a plurality of hydraulic cylinders.

Embodiment 17: The agricultural vehicle of Embodiment 16, wherein the harvesting header further comprises a header angle indicator.

Embodiment 18: The agricultural vehicle of Embodiment 17, further comprising a control system configured to adjust at least one of the hydraulic cylinders to change a position of the harvesting header, wherein the header angle indicator is configured to transmit a signal to the control system, the signal correlated to an orientation of the harvesting header.

Embodiment 19: The agricultural vehicle of Embodiment 18, wherein the header angle indicator comprises at least one distance sensor attached to a hydraulic cylinder of the plurality of hydraulic cylinders.

Embodiment 20: The agricultural vehicle of Embodiment 18 or Embodiment 19, wherein the control system is configured to adjust at least one of the hydraulic cylinders to move the harvesting header to a known position responsive to an operator input.

Embodiment 21: The agricultural vehicle of Embodiment 20, wherein the control system is configured to adjust at least one of the hydraulic cylinders to move the harvesting header to a position tilted at a known angle with respect to a horizontal orientation responsive to the operator input.

Embodiment 22: The agricultural vehicle of Embodiment 20 or Embodiment 21, wherein the control system is configured to adjust at least one of the hydraulic cylinders to move the harvesting header to a substantially horizontal position responsive to the operator input.

Embodiment 23: A method of operating an agricultural vehicle, the method comprising adjusting at least one hydraulic cylinder coupling a header frame of a harvesting header to the agricultural vehicle to move the header frame to a known orientation, sensing a position of an oil surface in a gearbox coupled to the header frame and containing a plurality of gears, and determining an amount of oil in the gearbox based at least in part on the position of the oil surface. At least some of the plurality of gears are coupled to rotary cutters, each rotary cutter having a rotating disc with at least one blade for cutting crops extending from the rotating disc.

Embodiment 24: The method of Embodiment 23, further comprising stopping rotation of the gears before sensing a position of the oil surface.

Embodiment 25: The method of Embodiment 23 or Embodiment 24, wherein adjusting at least one hydraulic cylinder comprises moving the header frame to a substantially horizontal position.

Embodiment 26: The method of any one of Embodiment 23 through Embodiment 25, wherein sensing a position of the oil surface in the gearbox comprises transmitting an acoustic signal toward the oil surface and receiving a reflected acoustic signal from the oil surface.

Embodiment 27: The method of any one of Embodiment 23 through Embodiment 26, further comprising, if the amount of oil in the gearbox is determined to be below a predetermined threshold, providing a warning to an operator of the agricultural vehicle.

Embodiment 28: The method of any one of Embodiment 23 through Embodiment 27, further comprising providing a visual indicator of the amount of oil in the gearbox to an operator of the agricultural vehicle.

Embodiment 29: The method of any one of Embodiment 23 through Embodiment 28, wherein determining an amount of oil in the gearbox is based at least in part on the known orientation of the header frame.

Embodiment 30: The method of any one of Embodiment 23 through Embodiment 29, wherein adjusting at least one hydraulic cylinder comprises measuring an orientation of the header frame.

Embodiment 31: The method of any one of Embodiment 23 through Embodiment 30, wherein determining an amount of oil in the gearbox comprises determining the amount of oil in the gearbox without opening the gearbox.

Embodiment 32: The method of any one of Embodiment 23 through Embodiment 31, wherein determining an amount of oil in the gearbox comprises determining the amount of oil in the gearbox without removing oil from the gearbox.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

1. A harvesting header comprising:
a header frame;
a plurality of rotary cutters carried by the header frame, wherein each rotary cutter has a rotating disc with at least one blade for cutting crops extending from the rotating disc;
a gearbox containing at least one gear coupled to each rotary cutter; and
an electronic sensor configured to indicate an amount of oil in the gearbox.

2. The harvesting header of claim 1, wherein the electronic sensor comprises an acoustic sensor.

3. The harvesting header of claim 2, wherein the acoustic sensor is configured to transmit an acoustic signal toward an oil surface in the gearbox and receive a reflected acoustic signal from the oil surface in the gearbox.

4. The harvesting header of claim 2, wherein the acoustic sensor is configured to transmit an acoustic signal below an oil surface in the gearbox and receive a reflected acoustic signal from the gearbox.

5. The harvesting header of claim 2, wherein the acoustic sensor is configured to transmit an acoustic signal into a head space in the gearbox above an oil surface and receive a reflected acoustic signal from the head space.

6. The harvesting header of claim 1, wherein the electronic sensor comprises an optical sensor.

7. The harvesting header of claim 6, wherein the optical sensor is configured to transmit an optical signal and receive a reflected optical signal from the surface of the oil.

8. The harvesting header of claim 6, wherein the optical sensor is configured to transmit an optical signal through the oil.

9. The harvesting header of claim 1, wherein the electronic sensor comprises a capacitive sensor.

10. The harvesting header of claim 1, wherein the electronic sensor is configured to identify a physical property of oil in the gearbox.

11. The harvesting header of claim 1, wherein the harvesting header further comprises a header angle indicator.

12. The harvesting header of claim 11, wherein the header angle indicator comprises a reference level comprising a fluid container fluidly separate from the gearbox.

13. The harvesting header of claim 11, wherein the header angle indicator comprises an electronic sensor.

14. The harvesting header of claim 11, wherein the header angle indicator comprises a sight glass.

15. The harvesting header of claim 11, wherein the oil level indicator is configured to indicate the amount of oil in the gearbox based at least in part on information from the header angle indicator.

16. An agricultural vehicle comprising:
a vehicle frame;
at least one wheel attached to the vehicle frame; and
the harvesting header of claim 1 coupled to the vehicle frame by a plurality of hydraulic cylinders.

17. The agricultural vehicle of claim 16, wherein the harvesting header further comprises a header angle indicator.

18. The agricultural vehicle of claim 17, further comprising a control system configured to adjust at least one of the hydraulic cylinders to change a position of the harvesting header, wherein the header angle indicator is configured to transmit a signal to the control system, the signal correlated to an orientation of the harvesting header.

19. The agricultural vehicle of claim 18, wherein the header angle indicator comprises at least one distance sensor attached to a hydraulic cylinder of the plurality of hydraulic cylinders.

20-22. (canceled)

23. A method of operating an agricultural vehicle, the method comprising:
adjusting at least one hydraulic cylinder coupling a header frame of a harvesting header to the agricultural vehicle to move the header frame to a known orientation;
sensing a position of an oil surface in a gearbox coupled to the header frame and containing a plurality of gears, wherein at least some of the plurality of gears are coupled to rotary cutters, each rotary cutter having a rotating disc with at least one blade for cutting crops extending from the rotating disc; and
determining an amount of oil in the gearbox based at least in part on the position of the oil surface.

24-32. (canceled)
